(19) United States
(12) Patent Application Publication
(10) Pub. No.: US 2024/0236536 A9
(43) Pub. Date: Jul. 11, 2024

(54) WIRELESS BLUETOOTH EARPHONE

(71) Applicant: LUXSHARE ELECTRONIC TECHNOLOGY (KUNSHAN) LTD., Kunshan City (CN)

(72) Inventors: Zhe FENG, Kunshan City (CN); Ji WEI, Kunshan City (CN); Qinghong ZHAO, Kunshan City (CN); Kai CHE, Kunshan City (CN); Linggang MENG, Kunshan City (CN)

(73) Assignee: LUXSHARE ELECTRONIC TECHNOLOGY (KUNSHAN) LTD., Kunshan City (CN)

(21) Appl. No.: 18/072,945

(22) Filed: Dec. 1, 2022

(30) Foreign Application Priority Data
Oct. 19, 2022 (CN) 202211279413.9

(51) Int. Cl. H04R 1/04; H04R 5/033; H04R 5/04

(52) U.S. Cl. CPC H04R 1/04; H04R 5/033; H04R 5/04; H04R 2420/07

(57) ABSTRACT

Provided is a wireless Bluetooth earphone, which belongs to the field of headphone technology. The wireless Bluetooth earphone comprises a housing, a circuit board, a battery, a connection ring, and a connection terminal. The housing comprises a main housing and a battery housing. The circuit board is arranged in the main housing. The connection ring has a first end and a second end. The first end is connected to one end of the main housing, that is, the first end is connected to one end of the rear housing arranged with an opening. The second end is detachably connected to the battery housing, and the battery is arranged in the battery housing. The connection terminal is arranged in the connection ring. One end of the connection terminal is electrically connected to the circuit board, and the other end of the connection terminal is electrically connected to the battery.

### CROSS-REFERENCE TO RELATED APPLICATION(S)

This application claims priority to Chinese Patent Application No. 202211279413.9 filed Oct. 19, 2022, the disclosure of which is incorporated herein by reference in its entirety.

### TECHNICAL FIELD

The present disclosure relates to the technical field of headphone technology, and in particular, to a wireless Bluetooth earphone.

### BACKGROUND

Generally, Bluetooth earphones are equipped with a Bluetooth headset charging case for charging the Bluetooth earphones when the Bluetooth earphones are not in use. At present, the endurance of Bluetooth earphones on the market is relatively low. After the earphones run out of power, the earphones cannot be used temporarily and need to be put back into the charging case for charging. Therefore, the earphones cannot be used continuously for a long time, which is not friendly to users who need to use earphones continuously for a long time.

Therefore, there is an urgent need for a wireless Bluetooth headset to solve the above problems.

### SUMMARY

The object of the present disclosure is to provide a wireless Bluetooth earphone to enable the battery of the Bluetooth earphone to be conveniently replaced, thereby improving the user experience.

To achieve this object, the present disclosure adopts the technical solutions below.

A wireless Bluetooth earphone includes a housing, a circuit board and a battery. The housing includes a main housing and a battery housing, and the circuit board is arranged in the main housing. The wireless Bluetooth earphone further includes a connection ring and a connection terminal.

The connection ring has a first end and a second end. The first end is connected to one end of the main housing, and the second end is detachably connected to the battery housing. The battery is arranged in the battery housing.

The connection terminal is arranged in the connection ring. One end of the connection terminal is electrically connected to the circuit board, and the other end of the connection terminal is electrically connected to the battery.

The connection terminal is an elastic terminal.

The connection terminal is U-shaped.

The wireless Bluetooth earphone further includes a first connection structure. The first connection structure includes a first connection portion and a second connection portion. The first connection portion is arranged at the connection ring, and the second connection portion is arranged at the battery housing. The connection ring and the battery housing are detachably connected through the first connection portion and the second connection portion.

The first connection portion is a connection groove arranged on an outer wall of the connection ring. The connection groove includes a first locking slot and a second locking slot which are communicated with each other. The first locking slot is arranged at the second end of the connection ring and extends in a central axis direction of the connection ring, and the second locking slot extends in a circumferential direction of the connection ring.

The second connection portion includes a protrusion arranged on an inner wall of the battery housing. When the connection ring is connected to the battery housing, the protrusion is capable of being engaged with the second locking slot through the first locking slot.

The wireless Bluetooth earphone further includes a terminal mounting plate. The terminal mounting plate is arranged in the connection ring, and the connection terminal is arranged at the terminal mounting plate.

The wireless Bluetooth earphone further includes a connection member. The terminal mounting plate is electrically connected to the circuit board through the connection member, and the connection terminal is electrically connected to the terminal mounting plate.

The connection member is a cable or a flexible circuit board.

The wireless Bluetooth earphone further includes a second connection structure. The second connection structure is arranged in the connection ring, and the second connection structure is capable of fixing the terminal mounting plate.

The second connection structure includes a fixing plate. The fixing plate is arranged in the connection ring, the terminal mounting plate is arranged on a side of the fixing plate facing the battery housing, and the fixing plate is arranged with an avoidance hole corresponding to the connection member.

The present disclosure has the beneficial effects below.

In the wireless Bluetooth earphone arranged by the present disclosure, the connection ring connected to the main housing is arranged, and the battery housing and the connection ring are detachably connected. When the battery in the battery housing runs out of power, the battery housing can be separated from the connection ring to make the power-deficient battery disconnected from the connection terminal, the power-deficient battery is removed, and the fully charged battery is put into the battery housing. After the battery housing is connected to the main housing, the fully charged battery is connected to the connection terminal to achieve the continuous power supply, thereby enabling the wireless Bluetooth earphone in the embodiment to continue to be used and improving the user experience.

### BRIEF DESCRIPTION OF DRAWINGS

FIG. 1 is a perspective view of a wireless Bluetooth earphone according to an embodiment of the present disclosure;

FIG. 2 is a side view of a wireless Bluetooth earphone according to an embodiment of the present disclosure;

FIG. 3 is a sectional view taken along A-A of FIG. 2; and

FIG. 4 is an exploded view of a wireless Bluetooth earphone according to an embodiment of the present disclosure;

### REFERENCE LIST

1 housing
11 main housing
111 front housing
112 rear housing
12 battery housing
2 circuit board
3 battery
4 connection ring
41 first end
42 second end
5 connection terminal
6 first connection structure
61 connection groove
611 first locking slot
612 second locking slot
62 protrusion
7 terminal mounting plate
8 connection member
9 fixing plate
91 avoidance hole.

### DETAILED DESCRIPTION

In the description of the present disclosure, it is to be noted that orientations or position relations indicated by terms such as “center”, “upper”, “lower”, “left”, “right”, “vertical”, “horizontal”, “in”, and “out” are based on the drawings. These orientations or position relations are intended to facilitate and simplify the description of the present disclosure and not to indicate or imply that a device or component referred to must have such particular orientations or must be configured or operated in such particular orientations. Thus, these orientations or position relations are not to be construed as limiting the present disclosure. Moreover, terms such as “first” and “second” are used for the purpose of description and are not to be construed as indicating or implying relative importance. Terms “first position” and “second position” are two different positions.

Unless otherwise expressly specified and limited, the term “mounting”, “connected to each other”, “connected” or “fixed” is to be construed in a broad sense, for example, as securely connected or detachably connected; mechanically connected or electrically connected; directly connected to each other or indirectly connected to each other via an intermediary; or internally connected between two components or interactional relationships between two components. For those of ordinary skilled in the art, specific meanings of the preceding terms in the present disclosure may be understood based on specific situations.

Unless otherwise expressly specified and limited, when a first feature is described as “above” or “below” a second feature, the first feature and the second feature may be in direct contact or be in contact via another feature between the two features instead of being in direct contact. Moreover, when the first feature is described as “on”, “above” or “over” the second feature, the first feature is right on, above or over the second feature, the first feature is obliquely on, above or over the second feature, or the first feature is simply at a higher level than the second feature. When the first feature is described as “under”, “below” or “underneath” the second feature, the first feature is right under, below or underneath the second feature, the first feature is obliquely under, below or underneath the second feature, or the first feature is simply at a lower level than the second feature.

Technical solutions of the present disclosure are further described hereinafter in conjunction with the drawings and the embodiments.

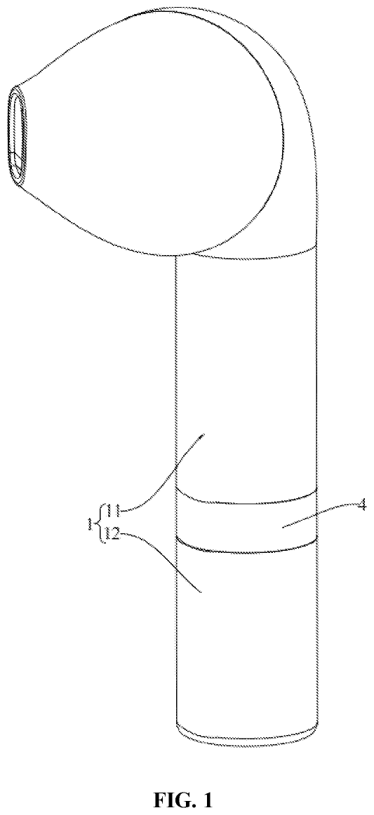

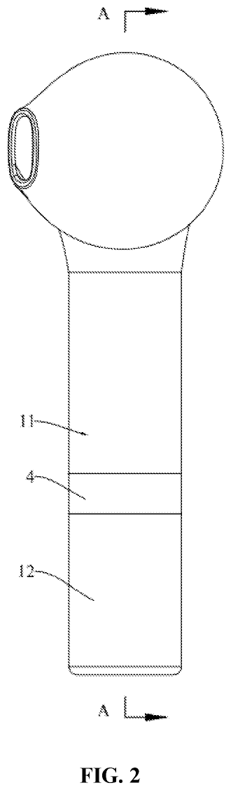

The present application provides a wireless Bluetooth earphone. As shown in FIGS. 1 to 4, the wireless Bluetooth earphone includes a housing 1, a circuit board 2, a battery 3, a connection ring 4 and a connection terminal 5. The housing 1 includes a main housing 11 and a battery housing 12, and the circuit board 2 is arranged in the main housing 11. Specifically, the main housing 11 includes a front housing 111 and a rear housing 112. One end of the rear housing 112 is connected to the front housing 111, the other end of the rear housing 112 is arranged with an opening, and the circuit board 2 is arranged in the rear housing 112.

Further, the connection ring 4 has a first end 41 and a second end 42. The first end 41 is connected to one end of the main housing 11, that is, the first end 41 is connected to one end of the rear housing 112 arranged with the opening. The second end 42 is detachably connected to the battery housing 12, and the battery 3 is arranged in the battery housing 12. The connection terminal 5 is arranged in the connection ring 4. One end of the connection terminal 5 is electrically connected to the circuit board 2, and the other end of the connection terminal 5 is electrically connected to the battery 3.

In this embodiment, the connection ring 4 connected to the main housing 11 is arranged, and the battery housing 12 and the connection ring 4 are detachably connected. When the battery 3 in the battery housing 12 runs out of power, the battery housing 12 can be separated from the connection ring 4 to make the power-deficient battery 3 disconnected from the connection terminal 5, the power-deficient battery 3 is removed, and the fully charged battery 3 is put into the battery housing 12. After the battery housing 12 is connected to the main housing 11, the fully charged battery 3 is connected to the connection terminal 5 to achieve the continuous power supply, thereby enabling the wireless Bluetooth earphone in this embodiment to continue to be used and improving the user experience.

In this embodiment, the connection terminal 5 is an elastic terminal. In this manner, the battery 3 can be fixed in the battery housing 12 so that the battery 3 can be stably connected to the connection terminal 5, thereby achieving reliable power supply.

In some embodiments, the elastic terminal is U-shaped. Specifically, the opening of the elastic terminal faces the side wall of the connection ring 4, and one of the opposite side walls of the elastic terminal can be in contact with the contact point at the battery 3.

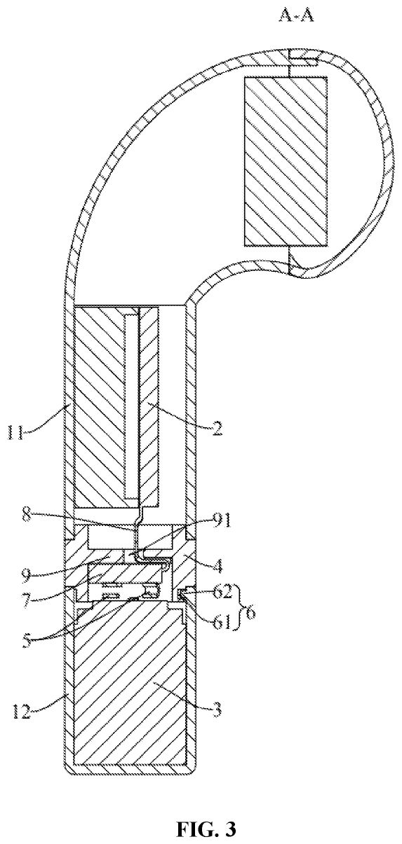

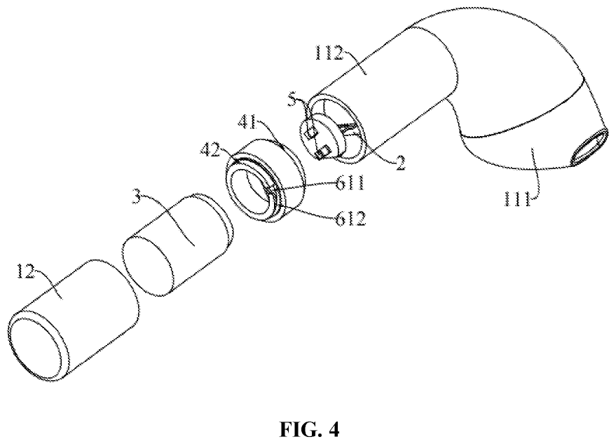

In order to achieve the detachable connection between the battery housing 12 and the connection ring 4, as shown in FIGS. 3 and 4, the wireless Bluetooth earphone in this embodiment further includes a first connection structure 6. The first connection structure 6 includes a first connection portion and a second connection portion. The first connection portion is arranged at the connection ring 4, and the second connection portion is arranged at the battery housing 12. The connection ring 4 and the battery housing 12 are detachably connected through the first connection portion and the second connection portion.

In some embodiments, the first connection portion is a connection groove 61 arranged on an outer wall of the connection ring 4. The connection groove 61 includes a first locking slot 611 and a second locking slot 612 which are communicated with each other. The first locking slot 61 is arranged at the second end 42 of the connection ring 4 and extends in a central axis direction of the connection ring 4, and the second locking slot 612 extends in a circumferential direction of the connection ring 4. The second connection portion includes a protrusion 62 arranged on an inner wall of the battery housing 12, and when the connection ring 4 is connected to the battery housing 12, the protrusion 62 is capable of being engaged with the second locking slot 612 through the first locking slot 611.

It is to be understood that since the thickness of the wall of the main housing 11 is relatively thin, the connection ring 4 is arranged so that the connection groove 61 can be easily opened. When the battery housing 12 and the connection ring 4 need to be connected, the first locking slot 611 is made to correspond to the position of the protrusion 62, and the battery housing 12 is inserted into the connection ring 4. After the protrusion 62 is moved to the position where the first locking slot 611 and the second locking slot 612 communicate, the battery housing 12 is rotated so that the protrusion 62 is slid into the second locking slot 612 to achieve the connection between the battery housing 12 and the connection ring 4. After the protrusion 62 is slid into place, the connection terminal 5 contacts the contact point at the battery 3. When the battery housing 12 and the connection ring 4 need to be separated, the battery housing 12 is rotated in the reverse direction, and when the projection 62 is slid to the position where the first locking slot 611 and the second locking slot 612 are connected, the battery housing 12 is moved in the direction away from the connection ring 4 so that the battery housing 12 is separated from the connection ring 4, thereby enabling the operation to be efficient and fast.

In other embodiments, the battery housing 12 and the connection ring 4 may be detachably connected in other manners. For example, the outer wall of the second end 42 of the connection ring 4 is arranged with external threads, the battery housing 12 is arranged with internal threads, and the battery housing 12 and the connection ring 4 are detachably connected through the connection of threads. The manner of the detachable connection between the battery housing 12 and the connection ring 4 is not limited herein.

As shown in FIGS. 3 and 4, the wireless Bluetooth earphone in this embodiment further includes a terminal mounting plate 7. The terminal mounting plate 7 is arranged in the connection ring 4, and the connection terminal 5 is arranged at the terminal mounting plate 7 so that the connection terminal 5 is fixed.

In order to achieve the electrical connection between the electronics mounting plate and the circuit board 2, the wireless Bluetooth earphone in this embodiment further includes a connection member 8. The terminal mounting plate 7 is electrically connected to the circuit board 2 through the connection member 8, and the connection terminal 5 is electrically connected to the terminal mounting plate 7.

In this embodiment, the connection member 8 is a cable or a flexible circuit board 2. The mounting space in the main housing 11 is limited, and the cable or the flexible circuit board 2 can be bent so that the connection between the terminal mounting plate 7 and the circuit board 2 can be easily achieved, thereby saving space.

In order to achieve the fixing of the terminal mounting plate 7, as shown in FIG. 3, the wireless Bluetooth earphone of this embodiment further includes a second connection structure. The second connection structure is arranged in the connection ring 4, and the second connection structure is capable of fixing the terminal mounting plate 7.

Further, the second connection structure includes a fixing plate 9. The fixing plate 9 is arranged in the connection ring 4, the terminal mounting plate 7 is arranged on a side of the fixing plate 9 facing the battery housing 12, and the fixing plate 9 is arranged with an avoidance hole 91 corresponding to the connection member 8. Specifically, the terminal mounting plate 7 is fixed in the connection ring 4, and the fixing plate 9 can limit the terminal mounting plate 7. The fixing plate 9 is arranged with an avoidance hole 91 corresponding to the connection member 8, and the connection member 8 penetrates through the avoidance hole 91 from the circuit board 2 and is connected to the terminal mounting plate 7.

The technical principle of the present disclosure is described above in conjunction with the embodiments. The description is used for explaining the principle of the present disclosure and is not intended to be explained in any means as limitations to the present disclosure. Based on the explanations herein, other embodiments of the present disclosure that occur to those skilled in the art are within the scope of the present disclosure without creative effort.

What is claimed is:

1. A wireless Bluetooth earphone, comprising a housing, a circuit board and a battery, wherein the housing comprises a main housing and a battery housing, the circuit board is arranged in the main housing, and the wireless Bluetooth earphone further comprises:
a connection ring having a first end and a second end, wherein the first end is connected to an end of the main housing, the second end is detachably connected to the battery housing, and the battery is arranged in the battery housing; and
a connection terminal arranged in the connection ring, wherein an end of the connection terminal is electrically connected to the circuit board, and an other end of the connection terminal is electrically connected to the battery.

2. The wireless Bluetooth earphone according to claim 1, wherein the connection terminal is an elastic terminal.

3. The wireless Bluetooth earphone according to claim 2, wherein the elastic terminal is U-shaped.

4. The wireless Bluetooth earphone according to claim 1, further comprising a first connection structure, wherein the first connection structure comprises a first connection portion and a second connection portion, the first connection portion is arranged at the connection ring, the second connection portion is arranged at the battery housing, and the connection ring and the battery housing are detachably connected through the first connection portion and the second connection portion.

5. The wireless Bluetooth earphone according to claim 4, wherein the first connection portion is a connection groove arranged at an outer wall of the connection ring, the connection groove comprises a first locking slot and a second locking slot which are communicated with each other, the first locking slot is arranged at the second end of the connection ring and extends in a central axis direction of the connection ring, and the second locking slot extends in a circumferential direction of the connection ring; and
the second connection portion comprises a protrusion arranged at an inner wall of the battery housing, and when the connection ring is connected to the battery housing, the protrusion is capable of being engaged with the second locking slot through the first locking slot.

6. The wireless Bluetooth earphone according to claim 1, further comprising a terminal mounting plate, wherein the terminal mounting plate is arranged in the connection ring, and the connection terminal is arranged at the terminal mounting plate.

7. The wireless Bluetooth earphone according to claim 6, further comprising a connection member, wherein the terminal mounting plate is electrically connected to the circuit board through the connection member, and the connection terminal is electrically connected to the terminal mounting plate.

8. The wireless Bluetooth earphone according to claim 7, wherein the connection member is a cable or a flexible circuit board.

9. The wireless Bluetooth earphone according to claim 6, further comprising a second connection structure, wherein the second connection structure is arranged in the connection ring, and the second connection structure is capable of fixing the terminal mounting plate.

10. The wireless Bluetooth earphone according to claim 9, wherein the second connection structure comprises a fixing plate, the fixing plate is arranged in the connection ring, and the terminal mounting plate is arranged at a side of the fixing plate facing the battery housing.

11. The wireless Bluetooth earphone according to claim 2, further comprising a terminal mounting plate, wherein the terminal mounting plate is arranged in the connection ring, and the connection terminal is arranged at the terminal mounting plate.

12. The wireless Bluetooth earphone according to claim 3, further comprising a terminal mounting plate, wherein the terminal mounting plate is arranged in the connection ring, and the connection terminal is arranged at the terminal mounting plate.

13. The wireless Bluetooth earphone according to claim 4, further comprising a terminal mounting plate, wherein the terminal mounting plate is arranged in the connection ring, and the connection terminal is arranged at the terminal mounting plate.

14. The wireless Bluetooth earphone according to claim 5, further comprising a terminal mounting plate, wherein the terminal mounting plate is arranged in the connection ring, and the connection terminal is arranged at the terminal mounting plate.
